(19) United States
(12) Patent Application Publication
(10) Pub. No.: US 2012/0124227 A1
(43) Pub. Date: May 17, 2012

(54) BROWSER-BASED VOIP SERVICE METHOD AND SYSTEM

(76) Inventors: NABIL AL-KHOWAITER, Dhahran (SA); ONUR YILDIRIM, Istanbul (TR)

(21) Appl. No.: 13/026,281

(22) Filed: Feb. 13, 2011

Related U.S. Application Data
(60) Provisional application No. 61/413,678, filed on Nov. 15, 2010.

(51) Int. Cl. G06F 15/16

(52) U.S. Cl. 709/228; 709/231

(57) ABSTRACT

A system is disclosed for providing browser-based VOIP services. The system includes a web server, a database server, a rendezvous server, and a streaming media server. The web server is configured to provide a web page for a user computer and a recipient computer to set up a call connection based on a computer-to-computer (CC) call link sent from the user computer to the recipient computer. The database server is coupled to the web server to provide user data. Further, the rendezvous server is configured to support a real time media flow protocol (RTMFP) to enable direct peer-to-peer communication between the user computer and the recipient computer to establish the call connection. The streaming media server is configured to support a real time messaging protocol (RTMP), an RTMP tunneled (RTMPT), and an RTMP secured (RTMPS) and to be a fail-over for the rendezvous server. Further, the CC call link is created by the web server upon a request from the user computer and sent to the recipient computer.

### CROSS-REFERENCES TO RELATED APPLICATIONS

This application claims the priority of U.S. provisional patent application No. 61/413,678, filed on Nov. 15, 2010, the entire contents of which are incorporated herein by reference.

### FIELD OF THE INVENTION

The present invention generally relates to Internet technologies and, more particularly, to the methods and systems for enabling web-browser based voice over IP (VOIP) services.

### BACKGROUND

Voice-over-IP (VoIP) technologies have become popular for providing a means of communication for casual and business users alike. The main appeal of VOIP technologies is the low cost. The Internet phone service transmits voice data packets through the Internet by using these VOIP technologies to connect Internet-enabled devices for making voice communications. The number of users using the Internet phone service keeps increasing.

However, even when the Internet phone service is gaining popularity, conventional Internet phone service technologies often make the interfaces of the phone services to the users quite complex. For example, a user of such conventional technology would have to go through a series of registrations and configurations in order to set up an account or a data object to use the Internet phone service. Some people, such as elderly or less-educated, may refuse to use such technologies due to fear of getting it wrong.

The disclosed methods and systems are directed to solve one or more problems set forth above and other problems.

### BRIEF SUMMARY OF THE DISCLOSURE

One aspect of the present disclosure includes a system for providing browser-based VOIP services. The system includes a web server, a database server, a rendezvous server, and a streaming media server. The web server is configured to provide a web page for a user computer and a recipient computer to set up a call connection based on a computer-to-computer (CC) call link sent from the user computer to the recipient computer. The database server is coupled to the web server to provide user data. Further, the rendezvous server is configured to support a real time media flow protocol (RTMFP) to enable direct peer-to-peer communication between the user computer and the recipient computer to establish the call connection. The streaming media server is configured to support a real time messaging protocol (RTMP), an RTMP tunneled (RTMPT), and an RTMP secured (RTMPS) and to be a fail-over for the rendezvous server. Further, the CC call link is created by the web server upon a request from the user computer and sent to the recipient computer.

Another aspect of the present disclosure includes a method for providing browser-based VOIP services. The method includes establishing a communication link with a user computer from a specific web page, receiving a request to create a computer-to-computer (CC) call link from a user of the user computer, and creating a CC call link including a fingerprint for the CC call link. The method also includes configuring the CC call link based on user information, which includes at least setting a maximum number of peers associated with the CC call link and setting an expiration date of the CC call link, and sending out the CC call link as a uniform resource locator (URL) based on a user requirement to one or more recipients.

Another aspect of the present disclosure includes a method for providing browser-based VOIP services. The method includes establishing a communication link with a user computer and receiving a request to create a computer-to-telephone (CT) call link from a user of the user computer. The method also includes creating the CT call link using a unique CT call link identifier, obtaining a user payment as a credit to the CT call link, and configuring the CT call link based on user information, including at least setting an expiration date of the CT call link. Further, the method includes sending out the CT call link as a uniform resource locator (URL) based on a user requirement to one or more recipients.

Other aspects of the present disclosure can be understood by those skilled in the art in light of the description, the claims, and the drawings of the present disclosure.

### BRIEF DESCRIPTION OF THE DRAWINGS

FIG. 1 illustrates an exemplary network environment incorporating certain aspects of the disclosed embodiments;

FIG. 2 illustrates a block diagram of an exemplary computing system consistent with the disclosed embodiments;

FIG. 3 illustrates an exemplary computer-to-computer sending process consistent with the disclosed embodiments;

FIG. 4A illustrates an exemplary computer-to-computer connecting process consistent with the disclosed embodiments;

FIG. 4B illustrates an exemplary browser window consistent with the disclosed embodiments;

FIG. 5 illustrates an exemplary computer-to-telephone sending process with the disclosed embodiments; and

FIG. 6 illustrates an exemplary computer-to-telephone connecting process consistent with the disclosed embodiments.

### DETAILED DESCRIPTION

Reference will now be made in detail to exemplary embodiments of the invention, which are illustrated in the accompanying drawings. Wherever possible, the same reference numbers will be used throughout the drawings to refer to the same or like parts.

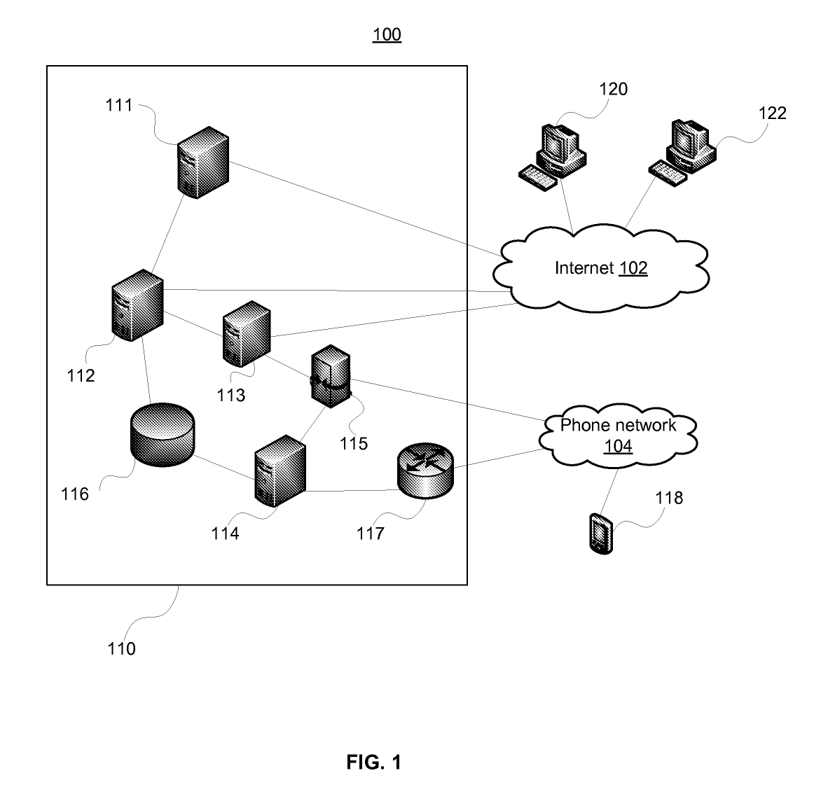

FIG. 1 illustrates an exemplary network environment incorporating certain aspects of the disclosed embodiments. As shown in FIG. 1, network environment 100 may include the Internet 102, a phone network 104, a service provider 110, a phone 118, and users (or user computers) 120 and 122. Other components may be added and certain devices may be removed without departing from the principles of the disclosed embodiments.

The Internet 102 may include any private and public computer networks interconnected using the standard transport control protocol/internet protocol (TCP/IP). Internet 102 may carry a large number of services over IP, such as the inter-linked hypertext documents of the World Wide Web (WWW) and electronic mail (or email). Internet 102 may connect a large number of websites. Further, Internet 102 may also carry voice-over IP (VOIP) services to enable voice or the like communications over Internet 102.

Service provider 110 may provide Internet based VOIP services. Service provider 110 may include any appropriate computer servers, software, and databases so as to provide various voice/video communication services. For example, as shown in FIG. 1, service provider 110 may include a web server 112, a rendezvous server 111, a streaming media server 113, a media gateway 115, an application server 114, a database server 116, and a VOIP router 117. Other systems may also be included and certain systems may be omitted without departing the principles of the disclosed embodiments.

Web server 112 may include one or more appropriate computer servers configured to provide VOIP services to users through Internet 102. For example, web server 112 may provide one or more websites to be accessed by the users for the VOIP services via HTTP or HTTPS. Web server 112 may also include other servers such as enterprise servers or any other servers for providing web-based services. Web server 112 may host any appropriate server software modules for providing web services, such as internet information services (IIS), Microsoft.NET framework, Adobe Flex & AS3, etc. Web server 112 may be coupled to database server 116, streaming media server 113, and rendezvous server 111 for data and service exchange.

Database server 116 may include one or more appropriate server computers configured to provide database services and database management services. Database server 116 may be used to store any appropriate data to be used by service provider 110, such as user data, configuration data, network data, and VOIP call related data. Database server 116 may be accessed by web server 112 and application server 114 or other servers during operation.

Rendezvous server 111 may include any appropriate media server supporting real time media flow protocol (RTMFP) to enable direct peer-to-peer communication between multiple user computers. For example, user computers 120 and 122 may be coupled to rendezvous server 111 through the RTMFP, based on UDP, such that communication data between user computers 120 and 122 may be directly streamed to each other, without going through the rendezvous server 111. To establish such peer-to-peer communication, the rendezvous server 111 may assign a call fingerprint to each peer and may introduce them to each other. Further, rendezvous server 111 is coupled to web server 112 to exchange user data and other call related data, such as usage data.

Streaming media server 113 may include any appropriate media server providing streaming data services. User computers 120 and 122 may be coupled to streaming media server 113 through real time messaging protocol (RTMP), RTMP tunneled (RTMPT), and RTMP secured (RTMPS), etc. Streaming media server 113 is coupled to web server 112 to exchange user data and other call related data, such as usage data. In operation, streaming media server 113 may be configured for streaming pre-recorded audio/video media to user computers 120 and 122, transferring incoming web-calls to media gateway 115, and being a fail-over alternative rendezvous server 111, etc.

Further, media gateway 115 may transcode an incoming media stream in a call into a real time transport protocol (RTP)-supported format (e.g., G.711 and G.729) and transfer the call to the SIP server 114, or directly to a destination address through phone network 104 over the RTP protocol.

Application server 114 may include one or more appropriate computer servers for providing specific applications. For example, application server 114 may include a server providing a phone service and thus may include an interface (not shown) to phone network 104. Thus, application server 114 may connect a computer to a phone 118 to make voice communication. For example, application server 114 may include a session initiation protocol (SIP) server 114, and SIP server 114 may manage user billing and call-credits when coupled to database server 116. SIP server 114 may also determine a least-cost VoIP service provider or network to use when coupled to the VoIP router 117. Further, during a call session, SIP server 114 may inform the media gateway 115 to transmit the call or may directly transmit the call.

Phone network 104 may include any appropriate phone network such as a VOIP network, a public switched telephone network (PSTN), a cellular network, or any other telephone networks. A VoIP Network may include multiple VoIP telephony service providers that provide different rates and service-quality for various countries and telecommunication networks. The SIP server 114 and VoIP router 117 may interactively determine and select a suitable VOIP service provider for a call being initiated. Phone 118 may include any appropriate land-line or wireless phones, smart phones, computers with soft-phones installed, IP phones, cell/mobile phones, PDAs, electronic pads or tablets, etc.

Other systems may also be provided in service provider 110. When a user computer is connected to a server in service provider 110, the user computer may also access other servers in service provider 110. Service provider 110 may also include a firewall (not shown) as a barrier for preventing unauthorized communications to service provider 110.

Further, user computers 120 and 122 may include any appropriate types of computers operated by users of service provider 110 to use the various services provided by service provider 110. For example, user computers 120 and 122 may include desktop computers, notebook computers, tablets, smart phones, and other types of computing platforms and software programs. Users of any of user computers 120 and 122 may communicate with one another based on the VOIP services from service provider 110. A user of any user computers 120 and 122 may also communicate with other devices, such as phone 118, over other networks, such as phone network 104, based on the VOIP services from service provider 110. Although two user computers 120 and 122 and one phone 118 are shown in FIG. 1, any number of user computers and phones may be included in network environment 100.

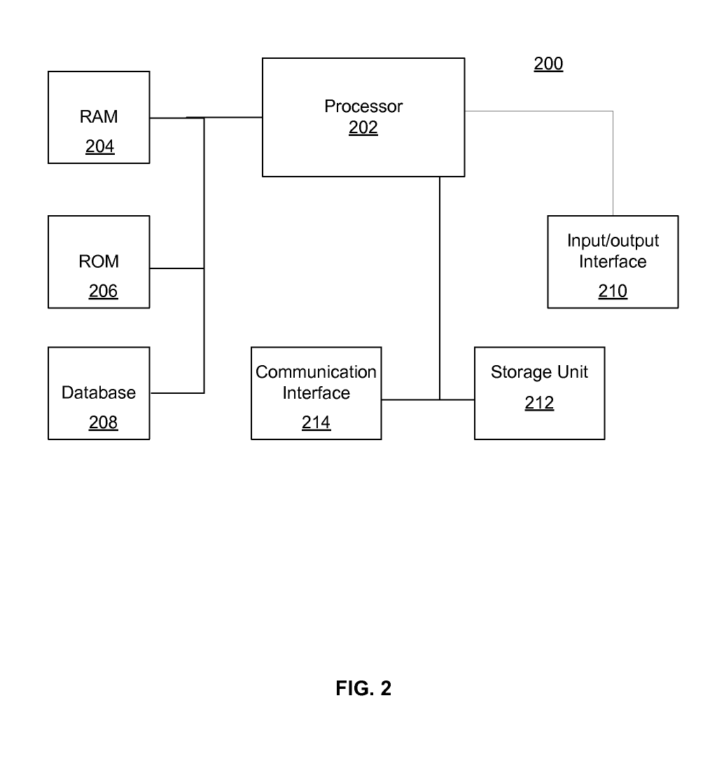

The various servers and computers, e.g., web server 112, rendezvous server 111, streaming media server 113, application server 114, database server 116, VOIP gateway 117, phone 118, and user computers 120 and 122, may be implemented using any appropriate computing systems. FIG. 2 shows a block diagram of an exemplary computing system 200.

As shown in FIG. 2, computing system 200 may include a processor 202, a random access memory (RAM) unit 204, a read-only memory (ROM) unit 206, a database 208, an input/output interface unit 210, a storage unit 212, and a communication interface 214. Other components may be added and certain devices may be removed without departing from the principles of the disclosed embodiments.

Processor 202 may include any appropriate type of graphic processing unit (GPU), general-purpose microprocessor, digital signal processor (DSP) or microcontroller, and application specific integrated circuit (ASIC), etc. Processor 202 may execute sequences of computer program instructions to perform various processes associated with computing system 200. The computer program instructions may be loaded into RAM 204 for execution by processor 202 from read-only memory 206.

Database 208 may include any appropriate commercial or customized database to be used by computing system 200, and may also include query tools and other management software for managing database 208. Further, input/output interface 210 may be provided for a user or users to input information into computing system 200 or for the user or users to receive information from computing system 200. For example, input/output interface 210 may include any appropriate input device, such as a remote control, a keyboard, a mouse, a microphone, a video camera or web-cam, an electronic tablet, voice communication devices, or any other optical or wireless input devices. Input/output interface 210 may include any appropriate output device, such as a display, a speaker, or any other output devices.

Storage unit 212 may include any appropriate storage device to store information used by computing system 200, such as a hard disk, a flash disk, an optical disk, a CR-ROM drive, a DVD or other type of mass storage media, or a network storage. Further, communication interface 214 may provide communication connections such that computing system 200 may be accessed remotely and/or communicate with other systems through computer networks or other communication networks via various communication protocols, such as TCP/IP, hyper text transfer protocol (HTTP), etc.

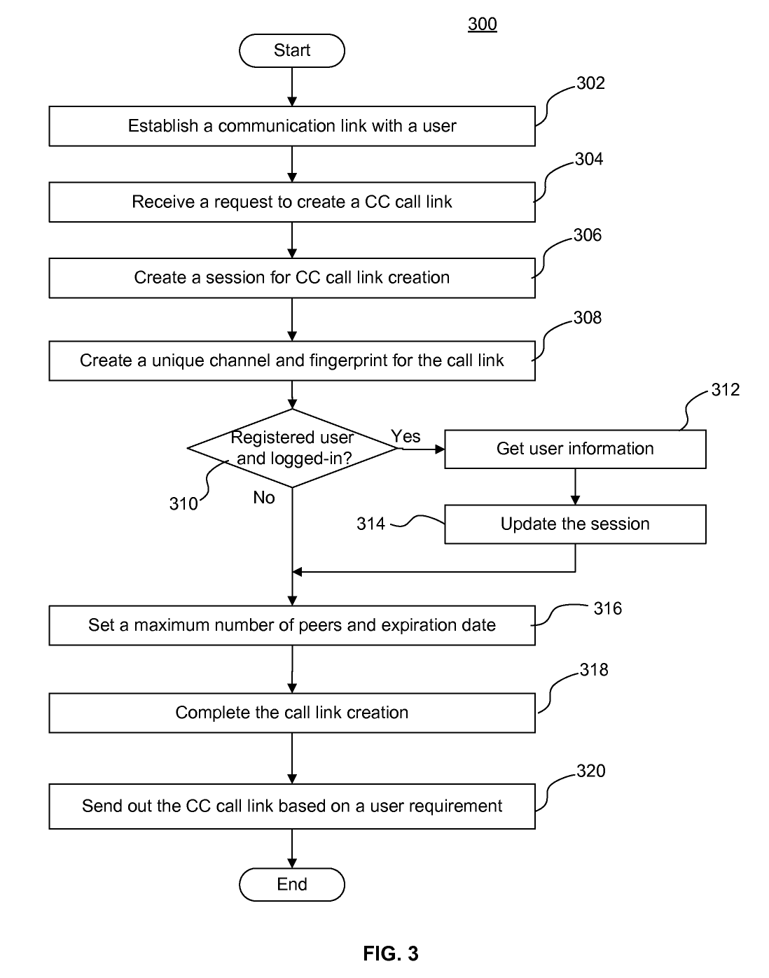

Returning to FIG. 1, during operation, service provider 110 may provide certain services to user computers 120 and 122. For example, web server 112, or processor 202 of a computing system implementing web server 112, may allow a user computer (e.g., user computer 120) to set up a simple link for connecting another user computer (e.g., user computer 122) over Internet 102. FIG. 3 shows an exemplary computer-to-computer sending process 300 performed by web server 112, or processor 202, consistent with the disclosed embodiments.

As shown in FIG. 3, at beginning, web server 112 or processor 202 may establish a communication link with a user of a user computer (e.g., user computer 120) (302). Web server 112 may be used for illustrative purposes to generally refer to any server within service provider 110 for service provision. Web server 112 may host a website for providing certain types of VOIP services, also called browser-based VOIP services. A browser-based VOIP service, as used herein, may refer to a web-based VOIP service having a website that has an icon which, when clicked, creates a special web link to a browser-based VOIP enabled website, and the website uses certain web browser software, such as Flash, to compress audio/visual data received from one browser and to deliver it via Internet (e.g., UDP Protocol) to two or more web browsers on different computers that are viewing the same page.

Web server 112 may host the website using a combination of hardware and software programs, such as ASP.NET and MS SQL server for the database operations. The user on user computer 120 may visit the website on web server 112 to obtain or setup a browser-based VOIP service. Further, the user computer 120 may include a web-browser having a browser software program or a plug-in software program using voice coding without loading active software components. Software component installation, registration, or loading, such as a Java applet, may be avoided. Web server 112 may thus establish an internet connection with user computer 120, such as an HTTP connection, such that the website can be viewed from the web-browser by the user from user computer 120.

When viewing the website on web server 112 via the browser, the user may want to set up a computer-to-computer (CC) call link from the website. For example, the user may click a link or a button from the website, and web server 112 may receive a request to create the CC call link (304). A CC call link, as used herein, may refer to any appropriate representation, such as an icon or a uniform resource locator (URL) or any other identifiers, that capable of being clicked to create the special web link for VOIP communications between two or more computers connected via Internet 102. Such call link or VOIP communications may support any other types of communication in addition to voice communication, such as video communication and text communication. For example, a user can set up the CC call link as an audio or video call URL to others for real-time voice or video communications (i.e., an instant chat URL). The user can also set up the CC call link as an audio/video message URL to others for messaging services (i.e., a message URL). Other types of CC call links may also be used.

Once the CC call link is created, the user may send this link to other people whom the user wants to communicate with via audio and/or video. When a recipient receives a link from the user and clicks on the link, the recipient's web browser is directed to a web page or browser that initiates an audio and/or video communication with the user.

The user may send the request in various ways. For example, the user may visit a specific web page on web server 112 and may request to create a CC call link from the specific web page. The user may also click a button or other icon from an external web page hosted on other server or servers other than service provider 110. Further, the user may be able to request to create a CC call link when accessing an existing CC call link that is no longer valid or is expired. Other ways may also be included.

After receiving the request to create the CC call link (304), web server 112 may create a session for the purpose of creating the CC call link (306). Web server 112 may create the session on web server 112 or service provider 110, and may also create cookies on the user computer of the user. Further, web server 112 (or rendezvous server 111) may create a CC call link with a unique channel and fingerprint for the CC call link (308). A fingerprint, as used herein, may refer to a data structure used to identify a particular call or CC call link and to define properties of the CC call link. Certain part of the fingerprint may be included in the CC call link as part of the CC call link. In addition, the cookies may refer to certain data structures created on the user computer to hold information about history of the interaction between the user computer and web server 112.

Further, web server 112 may determine whether the user is a registered user and whether the registered user is logged in (310). For example, web server 112 may check login information, if any, from a user database from database server 116, and may also check the session information or cookies on the user computer. If web server 112 determines that the user is a registered user (e.g., with a valid name and email address), web server 112 may also determine if the registered user is logged in. When web server 112 determines that the user is a registered user and the user is logged in (310; Yes), web server 112 may get user information from, for example, database server 116 (312), and may also update the session created for the call link creation (314) based on the additional user information. For example, web server 112 may update the session on web server 112 or other servers and may also update cookie information on the user computer.

On the other hand, if web server 112 determines that the user is not a registered user or the user is a registered user but is not logged in (310; No), web server 112 may skip any efforts to get user information or session update, because the user is not required to enter any user information. Under this circumstance, web server 112 may determine that the user information is not available. That is, if a user does not understand the technology or does not want to go through the trouble associated with registering with any kind of information technology (IT) or Internet services, the user does not need to register or enter any user information and is still able to use the VOIP services using the website provided by web server 112. Similarly, the recipient is not required to understand the technology or to provide any further information while using the VOIP services provided by web server 112. For example, with one click on an icon in the website, the user can create a URL that he/she can send to one or more users. When a recipient clicks on the same URL, the recipient is able to see and talk to the user and/or other recipients simultaneously, without downloading or being asked for registration for any software installation. For the audio/video message URL (e.g., an instant chat URL), the user may record a message first and then create and send the URL to other recipients. If recipients of the message URL click on it, the recipients are able to see and/or hear the sender's message for a predetermined period of time or number of clicks. Thus the message sender can set the message to be heard and/or seen only once, which is equivalent to a self-destructing recording. In addition, when the user sends an audio/video message URL to other recipients, the user may use the website to mix audio or video recordings from a local or online sound/music library with the message. The user can also use audio distortion software on the website to change the voice.

Further, web server 112 may set a maximum number of peers and expiration date for the CC call link (316). The maximum number of peers may refer to a maximum number of users who can join in a conference call based on the CC call link, and the expiration date of the CC call link may refer to a particular time beyond which the CC call link is expired. After the expiration date, the CC call link may become invalid. When setting the maximum number of peers, if the user is a logged in registered user, web server 112 may first determine whether the user is a premium user. A premium user may refer to a specially identified user or a paying user, such as a registered user with a valid credit card on file. When web server 112 determines that the user is a premium user, web server 112 may set an unlimited number of peers as the maximum number. When web server 112 determines that the logged in registered user is not a premium user, web server 112 may set a first predetermined number as the maximum number of peers, such as 6 or any appropriate numbers. Further, when web server 112 determines that the user is not a registered user or the user is not logged in, web server 112 may set a second predetermined number as the maximum number, such as 2, which indicates that no conference call is allowed if the user is not logged in or is anonymous. Any other numbers may be used. In addition, web server 112 may also set a default expiration date of the CC call link. For example, web server 112 may set twenty-four hours as the default expiration date of the CC call link, and the user may be able to change the default expiration date of the CC call link via an user interface. Other time periods may also be used.

Further, web server 112 may complete the CC call link creation (318). For example, web server 112 may set the user as the host for the CC call link, i.e., the user computer may host the call session when the CC call link is invoked or clicked by its recipients. The CC call link may include a series of numbers and letters to contain all information web server 112 needs to create the VOIP communication between the user and any of recipients of the CC call link. Under certain circumstances, the series of numbers and letters may be so long that it may be undesired to be used in the CC call link. Web server 112 may map such series of numbers and letters to a hash table such that a shorter unique identifier is used instead of the series of numbers and letters. Further, web server 112 may save the CC call link including the fingerprint in a database (e.g., database server 116) and may also update the session and cookies on the user computer.

Optionally, whether or not the user is a registered user, web server 112 may create a user identification data structure associated with the CC call link. If the user is not a registered user, web server 112 may create an anonymous user identification data structure. If the user is a register user, web server 112 may create a registered user identification data structure.

After completing the CC call link creation (318), web server 112 may notify the user or present the created CC call link to the user. The user may determine how to send out the generated CC call link to one or more recipients. Web server 112 may send out the CC call link based on a user requirement (320). For example, the user may indicate sending the link via an email and may also provide an email address of recipient(s), and web server 112 may send the CC call link to the identified email recipient(s) using email. If the user indicates to send the CC call link via a text message to a mobile phone, web server 112 may send the CC call link using a text message over, for example, phone network 104. The user may also schedule the CC call link to be sent in a future date/time. Other sending methods may also be used.

Alternatively or additionally, the user may also send the CC call link in other different ways. For example, the user may copy the CC call link and email or text the copied CC call link to one or more recipients. Or the user may include the CC call link in a social network posting. Other methods of sending a web link may be used.

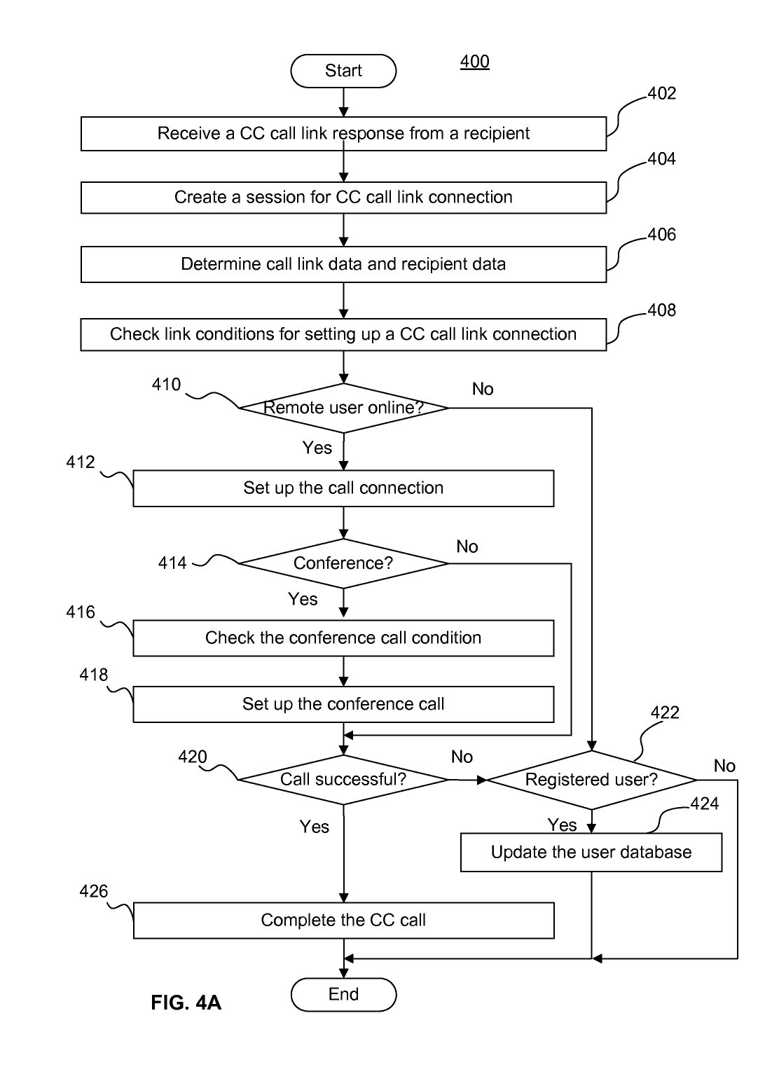

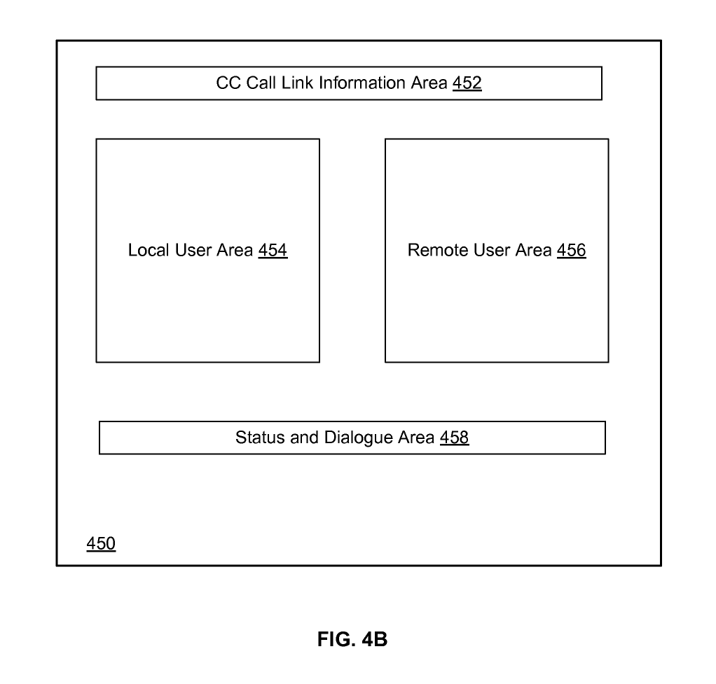

One or more recipients may receive the CC call link from web server 112 or from the user. A recipient may, for example, open an email including the CC call link and may click on the link, which leads the recipient to the website hosted on web server 112 via a web browser. FIG. 4A shows an exemplary computer-to-computer connecting process 400 performed by web server 112 or processor 202 consistent with the disclosed embodiments.

As shown in FIG. 4A, web server 112 may receive a CC call link response from one or more recipient(s) of the CC call link sent by the user (402). A recipient of the CC call link may click on the link or otherwise invoke the link, which may send out a response by a user computer (e.g., user computer 122) of the recipient to web server 112 such that the website of web server 112 may be visited by a browser on user computer 122. Optionally, if it is a first time the recipient clicks on the CC call link, the recipient may be asked by the browser via, for example, a pop-up window, whether the recipient wants to activate a microphone and/or a video camera to be used for the voice and/or video communication. FIG. 4B illustrates an exemplary browser window 450 for CC call link invocation on the user computer and may also applicable to other call link invocations.

As shown in FIG. 4B, a browser window 450 on the user computer may be connected to web server 112 to display a web page from web server 112 for a CC call based on the CC call link. Browser window 450 may include a CC call link information area 452, a local user area 454, a remote user area 456, and a status and dialogue area 458. Other display areas may also be included.

CC call link information area 452 may display any appropriate information associated with the CC call link currently invoked, such as the URL and other information. Local user area 454 may display information about the local user on the user computer, such as a video/camera display for video call or conference, and the local user may choose to enable or disable the video/camera during the call. For example, a user name or ID may be displayed in local user area 454. Further, similarly, remote user area 456 may display information about a remote user to be called. When the remote user answers the call, the remote user area 456 may display a video of the remote user or other images. Information displayed on the local user area 454 on the user computer may be displayed on remote user area 456 on the remote user computer. In addition, a status and dialogue area 458 may be provided to display certain status information and/or dialogue information during the call between the user and the remote user.

Returning to FIG. 4A, after receiving the CC call link response from the recipient or recipient computer (402), web server 112 may create a session for CC call link connection (404). For example, web server 112 may create the session on web server 112 or service provider 110 for CC call link connection, and may also create cookies on the recipient computer of the recipient. For example, web server 112 may create a browser session and the recipient computer may display a browser window as shown in FIG. 4B.

Further, when receiving the CC call link response, web server 112 may receive data associated with the CC call link response from the recipient, and may determine the CC call link and recipient data (406). For example, web server 112 may determine the CC call link identification such as the URL and the fingerprint of the CC call link. Web server 112 may also determine the identifier of the recipient, such as a network address and other information. Further, web server 112 may also determine a fingerprint of the CC call link and may search the database for the fingerprint to find the data record for the CC call link, such as information about the creating user and expiration date of the CC call link.

If web server 112 cannot find the data record of the fingerprint, web server 112 may determine that the CC call link is not valid and may inform the recipient computer on, for example, the status and dialogue area 458 of the browser window 450. Also, if web server 112 finds the data record for the CC call link, web server 112 may also determine whether the sender is a registered user and, if the sender is a registered user, may retrieve user information about the sender of the CC call link. For a user computer trying any unsuccessful invocation of a CC call link, web server 112 may also optionally switch the user computer to the web page for creating a new CC call link.

Based on the information determined and other operation information of web server 112, web server 112 may check link conditions for setting up a CC call connection between the user and the recipient (408). For example, web server 112 may determine an expiration date of the CC call link. If the CC call link is expired, web server 112 may also indicate such information to the recipient computer sending the CC call link response. Web server 112 may also determine a host for the CC call based on the data records associated with the fingerprint.

As previously explained, a sender of the CC call link may be the host for the call. However, the recipient computer may also be configured to be the host for the call. Further, web server 112 may also determine whether the remote user (e.g., sender of the CC call link or other remote users) is online (410). A user computer may be online if the user computer is connected to web server 112, i.e., on the same web site. Alternatively, a user computer may be considered as online if web server 112 can detect the user computer through the Internet 102. For example, web server 112 may determine whether the user is on the website of web server 112 or whether user computer 120 is connected via Internet 102 and is capable of receiving/sending data over Internet 102.

If the user is online (410; Yes), web server 112 may then start a peer-to-peer link between the recipient computer and the user computer to establish a CC voice connection or a multimedia connection (412). That is, for example, the CC call connection is based on a peer-to-peer link between user computer 120 (i.e., the user) and user computer 122 (i.e., the recipient) without going through web server 112.

Thus, web server 112 may be able to reduce the amount of resources used to set up such voice connections, and a significantly more number of users may be supported by web server 112.

That is, if web server 112 determines that the user is online (410; Yes), web server 112 may set up the peer-to-peer link between the user and the recipient (412). Further, web server 112 may also check whether the call is a conference connection (414). That is, web server 112 may determine whether a connection is already active between the user and another recipient based on the same CC call link sent by the user. Because the user may send out a plurality of CC call links, more than one recipient may click on the CC call link to communicate with the user.

If web server 112 determines that the connection between the recipient and the user is not a conference call, i.e., there is no other connection active associated with the CC call link from the user (414; No), web server 112 may continue the connection process from 420. On the other hand, if web server 112 determines that the connection between the recipient and the user is a conference call, i.e., there is an existing connection associated with the CC call link (414; Yes), web server 112 may check the conference call condition (416). For example, web server 112 may check whether a maximum number of peers is reached on this CC call link. If the maximum number is reached, web server 112 may indicate a failure to set up the requested conference call. Other conference call condition may also be used.

Web server 112 may set up a conference facility, such as an online chat room application, to setup the conference call (418). That is, web server 112 may add the recipient to the existing connection associated with the CC call link. Thus, the user and one or more recipients may be connected based on the CC call link sent by the user to the one or more recipients, the user and the one or more recipients may continue communicating with each other until the connection is terminated by the user, the one or more recipients, or by web server 112 based on predetermined criteria. In addition, web server 112 may assign a user name or ID for the user and/or recipient to be displayed in local user area 454 and/or remote user area 456 during the call or the conference call. Web server 112 may assign the user name or ID according to certain predetermined criteria. For example, for a registered user, web server 112 may assign the user name or ID retrieved from the database and displayed the retrieved user name or ID. For an unregistered user or a registered but not logged-in user, web server 112 may assign a random user name or ID that is unique for that call or conference call. Further, web server 112 may provide a user interface to allow the user to rename the random user name or ID during the call or conference call without re-loading the web page supporting the call or conference call.

Further, web server 112 may determine whether the call connection setup or conference call connection setup is successful (420). For example, web server 112 may determine whether the user answers the call connection or whether the communication quality is desired for the call connection. If web server 112 determines that the call connection setup is successful (420; Yes), web server 112 may continue monitor the call connection and complete the call connection after the user or the recipient terminates the call connection (426).

On the other hand, if web server 112 determines that the call connection setup is not successful (420; No), or if web server 112 determines that the remote user is not online (410; No), web server 112 may further check the user is a registered user (422). If the user is not registered (422; No), web server 112 may terminate the connecting process. If, however, the user is a registered user (422; Yes), web server 112 may update the user database to record the request, time, and failure of the connection 424), and may notify the user after the user comes online again. For example, web server 112 may notify the user via an email or a text message when a message URL or an instant chat URL sent by the user was opened when the user was not online.

Optionally, web server 112 may also assign a personal web page for a registered user during registration, such as a web page identified by “website URL/username,” such that the registered user can use the personal web page to store sent messages and/or receive audio/video messages from recipients who opened or clicked on a call link URL when the registered user is not online. Web server 112 may also provide a messaging interface for the user to receive voice or text messages from the recipient of the call link URL when the registered user is not online. Audio/video calls to the user while the user is not online may be listed on the personal page including related call information such as date, time, email, and name information, etc.

In addition, the registered user may use the personal page to list a certain number of other registered users of the web site such that the user may check the online status of the other registered users to see who is online.

Further, web server 112 may be configured to allow the user to create a personal talking blog web page. For example, the user can go to the personal web page every night and leaves an audio/video diary entry that is allowed for anyone to access or is limited for access with a password. A visitor to the personal web page can find a list of URLs with dates and time next to the list of URLs. If the visitor clicks on any one of the URLs, the visitor can see and/or hear the registered user's comments for that day.

In addition, web server 112 may be configured to allow the user to record the audio/video communications. For example, web server 112 may include a record button and record options on the web page controlling the audio/video communications (e.g., FIG. 4B) and the user may have the option to click on the record button to record the audio/video communications displayed in local user area 454 and/or remote user area 456. The user may record the audio only or both audio and video. For example, the user may record only the audio in an audio file (such as MP3), or both audio and video in a video file. Further, the user may also have the option to transcode the video file into other video formats such as MOV, WMV, MP4, etc., or to separate the audio from the video file and save the audio as an audio file such as MP3.

Further, during a conference, several remote user areas may appear during the communication, the user may record all communications of all remote user areas, or may select certain remote user areas to record the communications and store the recorded communications in one or more files. For example, communications associated with each remote user area may be recorded separately and separate files are created.

More specifically, web server 112 may provide a record button on the conference page, i.e., the web page configured for conferences, and may start a record operation for all the peer video communications in the conference when the user clicks on the record button. Web server 112 may also reduce the amount of information included in all the video communications and may merge all video communications in to a single video file, during or after the recording. The frame of the recorded video may contain split-screen videos. For example, if there are six parties in the conference including the user and five recipients, the final output video will have all the six videos in a reasonable-sized single frame such as a PAL (728×576 pixels) or HD (1920×1080 pixels) video size. Other formats or sizes may also be used. Further, as previously explained, the user may also select certain conference peers to record while ignoring the remaining peers.

The various created files may be stored on web server 112 or on the user computer (e.g., user computer 120 and 122) immediately. Web server 112 may also store the various files on the personal page of a registered user such that the user can stored the files locally or view the files on-line later.

As previously mentioned, web server 112 may set up the audio/video communication between the user and the recipient or recipients based on peer-to-peer connections using the rendezvous server 111 based on the RTMFP. Thus, during operation, when web server 112 receives an indication from the user after the user clicks on the record button, web server 112 may change the peer-to-peer connection between the user and the recipient(s) to be recorded from the RTMFP to the RTMP such that the communications (e.g., audio/video stream) go through web server 112. Web server 112 may thus record the audio/video stream at real-time. When the user clicks a stop button or the communication disconnects, web server 112 may switch the connection from the RTMP to the RTMFP for the peer-to-peer communication. Web server 112 may also create a video file (e.g., FLV) automatically and may also create a download link for the user. Optionally, the video file may be created on the user computer directly.

In addition to setting up voice communication between user computers connected by Internet 102 or other IP networks, web server 112 and application server 114 may also provide voice or multimedia communication between a computer and a phone 118 connected via phone network 104. Application server 114 may be coupled to phone network 104 to provide VOIP communication over phone network 104.

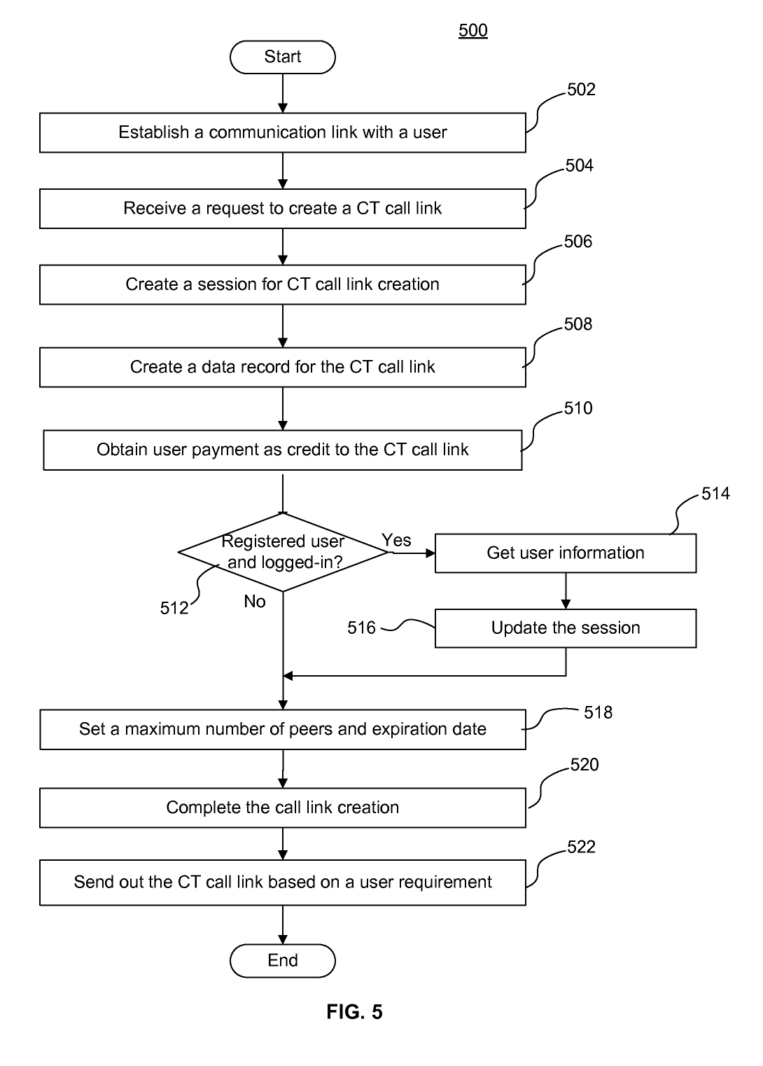

FIG. 5 shows an exemplary computer-to-telephone sending process 500 performed by web server 112, application server 114 or SIP server 114, or processor 202, consistent with the disclosed embodiments. As shown in FIG. 5, at beginning, web server 112 or processor 202 may establish a communication link with a user on a user computer (e.g., user computer 120) (502). As previously explained, web server 112 may host the website for providing VOIP services, and web server 112 may be used for illustrative purposes to generally refer to any server within service provider 110 for service provision. Web server 112 may also expand the VOIP services over phone network 104 using application server 114 to enable computer-to-telephone (CT) connections between a user (e.g., user computer 120) and phone 118 via PSTN.

When viewing the website on web server 112 via the browser, the user may want to setup a computer-to-telephone (CT) call link from the website. For example, the user may click a link or a button from the website, and web server 112 may receive a request to create the CT call link (504). A CT call link, as used herein, may refer to any appropriate representation, such as an icon or a uniform resource locator (URL) or any other identifiers, that capable of being clicked to create the special web link for VOIP communications between one or more computers connected via Internet 102 and one or more phones connected via phone network 104. Such call link or VOIP communications may also support any other types of communication in addition to voice communication, such as video communication. Once the CT call link is created, the user may send this link to one or more recipient(s). When a recipient receives a link from the user and clicks on the link, the recipient is taken to a web page or browser to allow the recipient to enter a telephone number and to initiate an audio and/or video communication to the entered phone number. For example, the web page may display a soft-phone interface in local user area 454 to dial the telephone number.

The user may send the request in various ways. For example, the user may visit a specific web page on web server 112 and may request to create a CT call link from the specific web page. The user may also click a button or other icon from an external web page hosted on other server or servers other than service provider 110. Further, the user may be able to request to create a CT call link when accessing an existing CT call link that is no longer valid or is expired. Other ways may also be included.

After receiving the request to create the CT call link (504), web server 112 may create a session for the purpose of creating the CT call link (506). Web server 112 may create the session on web server 112 or service provider 110, and may also create cookies on the user computer of the user. Web server 112 may also create a data record for the CT call link creation (508). For example, web server 112 may create a user identification data structure to be used in the CT call link and a call identification data structure for the CT call link.

Further, web server 112 may generate a CT call link based on the above information. The CT call link may include a series of numbers and letters to contain all information web server 112 needs to create the VOIP communication for the recipient to make a voice and/or video communication with a telephone. Under certain circumstances, the series of numbers and letters may be so long that it may be undesired to be used in the CT call link. Web server 112 may map such series of numbers and letters to a hash table such that a shorter unique identifier is used instead of the series of numbers and letters.

Web server 112 may also obtain a user payment as credit to the CT call link (510). The credit information may be associated with the CT call link. The user may determine a certain amount to be credited to the CT call link and may choose to pay the certain amount by any appropriate method. For example, the user may use his/her credit card or to use any other third-party payment methods. Or a registered user may indicate to use a credit card on file to pay for the credit without having to pay the credit at this point. As previously explained, such registered user with a valid credit card on file may be considered as a premium user and a personal web page may be assigned for the user. The premium user may use the personal web page to make a call to a PSTN phone or a third-generation (3G) audio/video call by clicking on a special link provided by web server 112. The premium user may also specify a predetermined phone number for the CT call link, such as the user's home phone or mobile phone number, etc., such that one or more recipients can call the predetermined number by clicking on the CT call link (e.g., a URL) without paying any extra charge. That is, the CT call link can be used for any recipient to call the user or the phone number identified by the user for unlimited calls as long as the CT call link is valid.

Further, web server 112 may determine whether the user is registered user and whether the registered user is logged in (512). For example, web server 112 may check login information, if any, or a user database from database server 116, may check the session information or cookies on the user computer. If web server 112 determines that the user is a registered user, web server 112 may also determine if the registered user is logged in. When web server 112 determines that the user is a registered user and the user is logged in (512; Yes), web server 112 may get user information from, for example, database server 116 (514), and may also update the session created for the call link creation based on the additional user information (516). For example, web server 112 may update the session on web server 112 or other servers and may also update cookie information on the user computer.

On the other hand, if web server 112 determines that the user is not a registered user or the user is a registered user but is not logged in (512; No), web server 112 may skip any efforts to get user information or session update, because the user is not required to enter any user information. Under this circumstance, web server 112 may determine that the user information is not available and the user is an anonymous user.

Further, web server 112 may set a maximum number of peers and expiration date for the CT call link (518). A default maximum number of peers may be set by web server 112 or the user may set the maximum number. Similarly, a default expiration date may also be set by web server 112 or the user may set the expiration date expressly. Or web server 112 may set the expiration date of a CT call link allowing a recipient to call any number as the time when the credit associated with the CT call link. For a CT call link with a predetermined phone number, web server 112 may set an indefinite expiration date as long as the user remains a premium user or a longer expiration date such as a year. Any appropriate expiration date may be used.

Further, web server 112 may complete the CT call link creation (520). For example, web server 112 may map series of numbers and letters in the CT call link to a hash table such that a shorter unique identifier is used instead of the series of numbers and letters. Further, web server 112 may save the CT call link including credit information and other data records and may also update the session and cookies on the user computer.

In addition, web server 112 may notify the user. The user may determine how to send out the generated CT call link to one or more recipients. Web server 112 may send out the CT call link based on a user requirement (522). For example, the user may indicate sending the link via an email and may also provide email addresses of the recipient(s), and web server 112 may send the CT call link to the identified email recipient(s) using email. If the user indicates to send the CT call link via a text message to a mobile phone, web server 112 may send the CT call link using a text message over, for example, phone network 104. Other sending methods may also be used.

Alternatively or additionally, the user may also send the CT call link in other different ways. For example, the user may copy the CT call link and email or text the copied CT call link to one or more recipient. Or the user may include the CT call link in a social network posting. Other methods of sending a web link may be used.

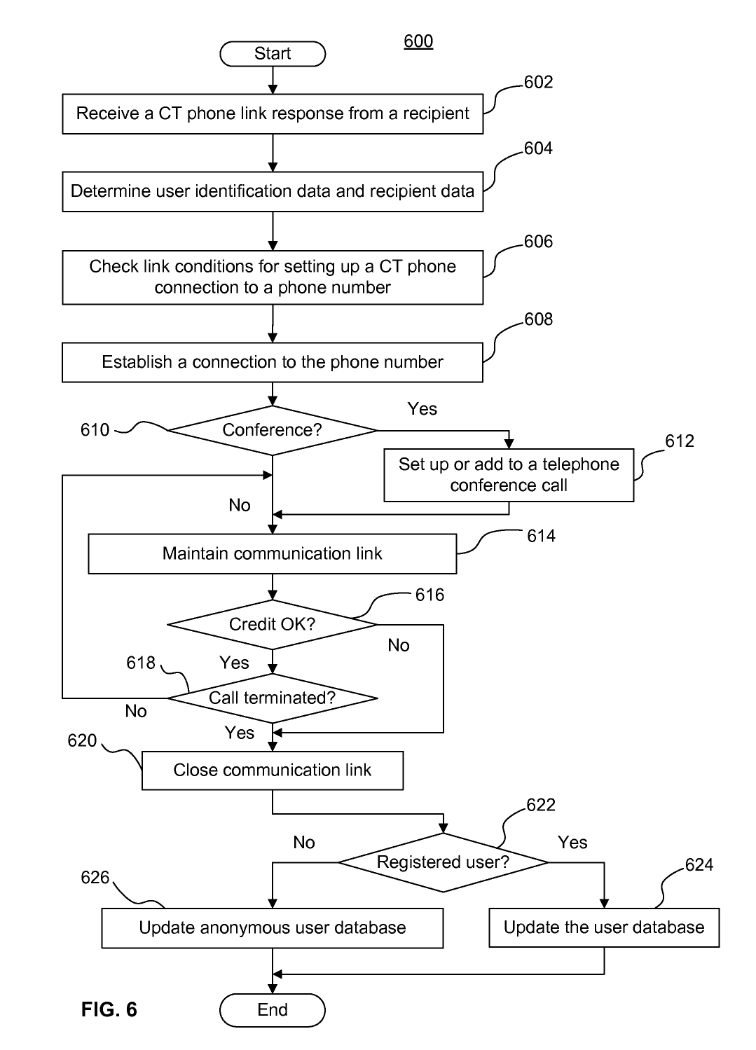

One or more recipients may receive the CT call link from web server 112 or from the user. A recipient may, for example, open an email including the CT call link and may click on the link, which leads the recipient to the website hosted on web server 112 via a web browser. FIG. 6 shows an exemplary computer-to-telephone connecting process 600 performed by web server 112, application server 114, or processor 202 consistent with the disclosed embodiments.

As shown in FIG. 6, web server 112 may receive a CT call link response from one or more recipient(s) of the CT call link sent by the user (602). For a recipient of the CT call link may click on the link, which may send out a response by a user computer (e.g., user computer 122) of the recipient to web server 112 such that the website of web server 112 may be visited by a browser on user computer 122. Optionally, if it is a first time the recipient clicks on the CT call link, the recipient may be asked by the browser via, for example, a pop-up window, whether the recipient wants to activate a microphone and/or a video camera to be used for the voice and/or video communication, if the telephone to be called by the recipient supports such communication types. As previously explained, a soft-phone interface may also be displayed to allow the recipient to enter a telephone number, or with a predetermined number.

Web server 112 may receive data associated with the CT call link response from the recipient, and may determine user identification data and other recipient related information (604). For example, web server 112 may determine the identifier of the sender or the user, and the identifier of the recipient, such as network address and other information. Further, web server 112 may also prompt the recipient to enter a phone number to which the recipient wants to make a voice communication, and also obtain the phone number inputted by the recipient.

Based on the information determined, the phone number inputted, and other operation information of web server 112, web server 112 may check link conditions for setting up a CT voice connection between the recipient and the phone number over phone network 104 (606). If the link condition is sufficient to support such connection, web server 112 may also establish the CT voice connection between the recipient and the phone number (608).

Application server 114 may be used to set up the CT voice connection. That is, the CT voice connection is not based on a peer-to-peer link between user computer 122 (i.e., the recipient) and a telephone (e.g., phone 118), and has to go through service provider 110 and phone network 104.

Web server 112 may also determine whether the connection is a conference connection (610). That is, web server 112 may determine whether a connection is already active to the same phone number or from the same recipient based on the same CT call link sent by the user. If web server 112 determines that the connection is not a conference call, i.e., there is no other connection active associated with the CT call link from the recipient or to the phone number (610; No), web server 112 or application server 114 may maintain the voice connection between the recipient and the phone number over phone network 104 (614). On the other hand, if web server 112 determines that the connection is a conference call, i.e., there is an existing connection associated with the CT call link from the recipient or to the phone number (610; Yes), web server 112 or application server 104 may set up a conference call or add the connection to an existing conference call (612).

Further, web server 112 or application server 114 may also check credit amount associated with the CT call link (616). As previously explained, the CT call link contains a certain amount of credit, which is used to pay for a total amount of time of any connections associated with the CT call link. Because the user may send out a plurality of CT call links, more than one recipient may click on the CT call link to communicate with external telephones. That is, all active connections by the recipient(s) share the total credit paid by the user. Thus, each active connection associated with the CT call link may be checked to ensure there is enough credit to support the active connections.

If there is no credit left on the CT call link or the credit check is not OK (616; No), the active connection may be terminated and the CT call link is marked as dead, i.e., expired. On the other hand, if the credit check is OK (616; Yes), web server 112 or application server 114 may further determine whether the connection is terminated (618).

If the connection is not terminated (618; No), web server 112 or application server 114 may go back to maintain communication link (614). If the connection is terminated (618; Yes), web server 112 or application server 114 may close the communication link (620). Of course, if there is a conference call, web server 112 or application server 114 may also terminate the conference call after all connections in the conference call are terminated.

Further, web server 112 may also check if the user is a registered user (622). If the user is not registered (622; No), web server 112 may update an anonymous user database (626). For example, web server 112 may record the usage, the credit balance, and other changed information. If, however, the user is a registered user (622; Yes), web server 112 may update the user database to record the request, time, usage, credit balance, and failure of the connection, etc. (624). Web server 112 may also record missed call or other statistics for the user (if the user is one either side of the voice communication), and may notify the user when the user is online.

In certain embodiments, the user may identify a particular phone number, such as the phone number of the user, to be associated with the CT call link such that any recipient of the CT call link can only call the particular phone number. Thus the user may be able to control the credit not being used in other phone conversations. Alternatively, the user may also identify several phone numbers as the possible destination phone numbers.

The disclosed systems and methods may provide many advantageous browser-based VOIP applications. For example, a VOIP service may be provided to connect people with a single click of the mouse. The user of the VOIP may no longer need to install any software other that the widely used web browser and associated software programs such as Flash Player, with a microphone and/or a camera. Further, the disclosed systems and methods may deliver audio/video through UDP-based RTMFP (real time media flow protocol) that enables direct P2P, low-latency, fast and secure media streaming.

What is claimed is:

1. A system for providing browser-based VOIP services, comprising:
a web server configured to provide a web page for a user computer and a recipient computer to set up a call connection based on a computer-to-computer (CC) call link sent from the user computer to the recipient computer;
a database server coupled to the web server to provide user data;
a rendezvous server configured to support a real time media flow protocol (RTMFP) to enable direct peer-to-peer communication between the user computer and the recipient computer to establish the call connection; and
a streaming media server configured to support a real time messaging protocol (RTMP), an RTMP tunneled (RTMPT), and an RTMP secured (RTMPS) and to be a fail-over for the rendezvous server,
wherein the CC call link is created by the web server upon a request from the user computer and sent to the recipient computer.

2. The system according to claim 1, wherein:
the CC call link is created without registration or entering any user information by a user of the user computer.

3. The system according to claim 2, wherein:
the call connection is initiated by a recipient of the recipient computer when the CC call link is clicked by the recipient.

4. The system according to claim 1, further including:
a media gateway configured to transcode an incoming media stream into a predetermined real-time-transport-protocol (RTP)-supported format; and
an application server coupled to the media gateway and configured to a phone service over a VOIP phone network,

5. A method for providing browser-based VOIP services, comprising:
establishing a communication link with a user computer from a specific web page;
receiving a request to create a computer-to-computer (CC) call link from a user of the user computer;
creating a CC call link including a fingerprint for the CC call link;
configuring the CC call link based on user information, including at least setting a maximum number of peers associated with the CC call link and setting an expiration date of the CC call link; and
sending out the CC call link as a uniform resource locator (URL) based on a user requirement to one or more recipients.

6. The method according to claim 5, wherein:
the user is an anonymous user, the CC call link is created by the user without registration or entering any user information, and the maximum number associated with the CC call link is set to a predetermined number.

7. The method according to claim 5, wherein the user is a premium user, and the maximum number associated with the CC call link is set to unlimited, the method further including:
assigning a personal web page to the user to store pre-recorded audio or video messages corresponding to the CC call link containing a message URL and to record messages from recipients of the CC call link containing an instant chat URL.

8. The method according to claim 5, further including:
mapping the CC call link to a hash table such that a shorter unique identifier is used to represent the CC call link.

9. The method according to claim 5, wherein sending out the CC call link includes:
sending the CC call link to the user to be forwarded to the one or more recipients by one of email, text messages, and social network posting.

10. The method according to claim 5, further including:
receiving a CC call link response from a recipient of the CC call link;
checking conditions for setting up a call between the recipient and the user; and
when the user is online, setting up the call as a peer-to-peer communication connection between the recipient and the user using a same web page being visited by both the recipient and the user.

11. The method according to claim 10, further including:
when the call is a conference call and the maximum number of peers are not reached, setting up the conference call connection.

12. The method according to claim 10, wherein:
the CC call link response is sent when the recipient of the CC call link clicks on the CC call link sent by the user, and the call is set up without loading additional software installation by the recipient.

13. The method according to claim 10, wherein checking conditions includes:
checking the expiration date of the CC call link.

14. The method according to claim 10, wherein:
when the user is a registered user and the user is not online, updating a user database to record information on the CC call link response;
allowing the recipient to record a message on a personal page assigned to the user on the specific web site; and
notifying the user about the call when the user comes online again by one of an email or a text message.

15. A method for providing browser-based VOIP services, comprising:
establishing a communication link with a user computer;
receiving a request to create a computer-to-telephone (CT) call link from a user of the user computer;
creating the CT call link using a unique CT call link identifier;
obtaining a user payment as a credit to the CT call link;
configuring the CT call link based on user information, including at least setting an expiration date of the CT call link; and
sending out the CT call link as a uniform resource locator (URL) based on a user requirement to one or more recipients.

16. The method according to claim 15, further including:
mapping the CT call link to a hash table such that a shorter unique identifier is used to represent the CT call link.

17. The method according to claim 15, wherein sending out the CT call link includes:
sending the CT call link to the user to be forwarded to the one or more recipients by one of email, text messages, and social network posting.

18. The method according to claim 15, further including:
receiving a CT call link response from a recipient of the CT call link;
obtaining a phone number from the recipient corresponding to a call connection requested by the recipient;
establishing a call connection between the recipient and the phone number over a VOIP phone network;
checking a credit condition associated with the CT call link for maintaining the call connection, wherein the call connection is closed when the credit condition is not desired for maintaining the call connection; and
updating a user database with respect to the CT call link to reflect at least a remaining credit.

19. The method according to claim 18, wherein:
when the credit condition associated with the CT call link is not desired for maintaining the call connection, the CT call link is marked as invalid.

20. The method according to claim 18, wherein:
the CT call link response is sent when the recipient of the CT call link clicked on the CT call link sent by the user.

21. The method according to claim 18, wherein:
the phone number is entered by the recipient from a soft-phone interface created when the recipient of the CT call link clicked on the CT call link sent by the user.

22. The method according to claim 18, wherein:
the phone number is predetermined by the user and contained in the CT call link.
